(19) United States
(12) Patent Application Publication
(10) Pub. No.: US 2010/0012090 A1
(43) Pub. Date: Jan. 21, 2010

(54) HYDROGEN DELIVERY SYSTEM AND METHOD FOR AN INTERNAL COMBUSTION ENGINE

(75) Inventor: JOSEPH E. LEWIS, III, COCOA BEACH, FL (US)

Correspondence Address: JESSICA W. SMITH, 1529 PARKVIEW DRIVE, GARLAND, TX, 75043, US

(73) Assignee: H2 SOLUTIONS, LLC, Houston, TX (US)

(21) Appl. No.: 12/178,852

(22) Filed: Jul. 24, 2008

Related U.S. Application Data
(60) Provisional application No. 61/081,714, filed on Jul. 17, 2008.

(51) Int. Cl. F02D 41/18; F02M 57/00; F02B 43/00

(52) U.S. Cl. 123/445; 123/3; 701/104

(57) ABSTRACT

An internal combustion engine includes an engine block assembly, an air intake system coupled to the engine block assembly and a hydrogen delivery system coupled to the air intake system. The hydrogen delivery system includes a control module that monitors an air flow rate through the air intake system. The control module determines a desired volume or mass of hydrogen to be injected into the air intake system in response to the air flow rate to produce a hydrogen to air ratio. As the air flow rate changes, the control module 120 continually updates the desired amount of hydrogen to be injected into the air intake system to produce a predetermined hydrogen to air ratio. The control module controls the hydrogen injector to provide a flow rate of hydrogen fuel to the air intake system to deliver the desired volume or mass of hydrogen.

### BACKGROUND OF THE INVENTION

1. Field of the Invention

The application generally relates to internal combustion engines, and more particularly to an improved system and method for hydrogen delivery to an internal combustion engine.

2. Description of the Related Art

In an internal combustion engine, fuel and an oxidizer are combined in a cylinder or combustion chamber. Typically engines use either a spark method or a compression method to achieve ignition. Through ignition, an exothermic chemical reaction or combustion occurs in the cylinder in which hot gases expand to move a part of the engine, such as a piston or a rotor. Typically, the oxidizer for an internal combustion engine is air, and the fuel is a hydrocarbon based fuel derived from petroleum or biomass, such as diesel, gasoline, petroleum gas, ethanol, biodiesal or propane or combination thereof.

The increasing cost of petroleum fuels for internal combustion engines has created a demand for greater fuel efficiency. One approach that has been developed is the addition of hydrogen to the combustion process. It has been found that when hydrogen is mixed with a hydrocarbon based fuel in the cylinder of an internal combustion engine, there is an improved combustion efficiency and a reduction of noxious emissions. In current systems, hydrogen is added to the air that is introduced into the cylinder. Typically, the same volume of hydrogen is added to the air regardless of air flow rate, engine load or engine revolution per minute (RPM) considerations.

As such, there is a need for an improved system and method for hydrogen delivery to an internal combustion engine.

### BRIEF SUMMARY OF THE INVENTION

The present invention is directed to a system and method for hydrogen delivery to an internal combustion engine as described in the following Brief Description of the Drawings, the Detailed Description of Embodiments of the Invention and The Claims. The features and advantages of the present invention will become apparent from the following detailed description of the invention made with reference to the accompanying drawings.

### BRIEF DESCRIPTION OF THE DRAWINGS

FIG. 1 is a schematic block diagram of an embodiment of an internal combustion engine with a hydrogen delivery system in accordance with the present invention.

FIG. 2 is a schematic block diagram of an embodiment of a hydrogen delivery system in accordance with the present invention.

FIG. 3 is a schematic block diagram of another embodiment of the hydrogen delivery system in accordance with the present invention.

FIG. 4 is a schematic block diagram of another embodiment of the hydrogen delivery system in accordance with the present invention.

FIG. 5 is a logic flow diagram of an embodiment of a method for hydrogen delivery in accordance with the present invention.

FIG. 6 is a logic flow diagram of another embodiment of a method for hydrogen delivery in accordance with the present invention.

### DETAILED DESCRIPTION OF THE INVENTION

While the invention will be described in connection with the preferred embodiments, it will be understood that it is not intended to limit the invention to those embodiments. On the contrary, it is intended to cover all alternatives, modifications, and equivalents thereof. Similar parts will be labeled with the same numbers in the figures though a person of skill in the art would appreciate that various alternatives, modifications and equivalents may be substituted for such similar parts.

As described above, the current systems for hydrogen delivery introduce a constant volume of hydrogen to the air intake system of an internal combustion engine regardless of air flow rate, engine load or engine revolutions per minute (RPM) considerations. However, the air flow rate through the air intake system varies. By only injecting an unvarying volume of hydrogen, different hydrogen to air ratios are produced in the air intake system and in the cylinders during the combustion process. This differing values of hydrogen to air rates in the cylinders creates inefficiencies in the combustion process. As such, there is a need for an improved system and method for hydrogen delivery to an internal combustion engine. An embodiment of the present invention monitors the flow rate of air and adjusts the delivery of hydrogen to the air intake system of the internal combustion engine to optimize the hydrogen to air ratio for the internal combustion engine.

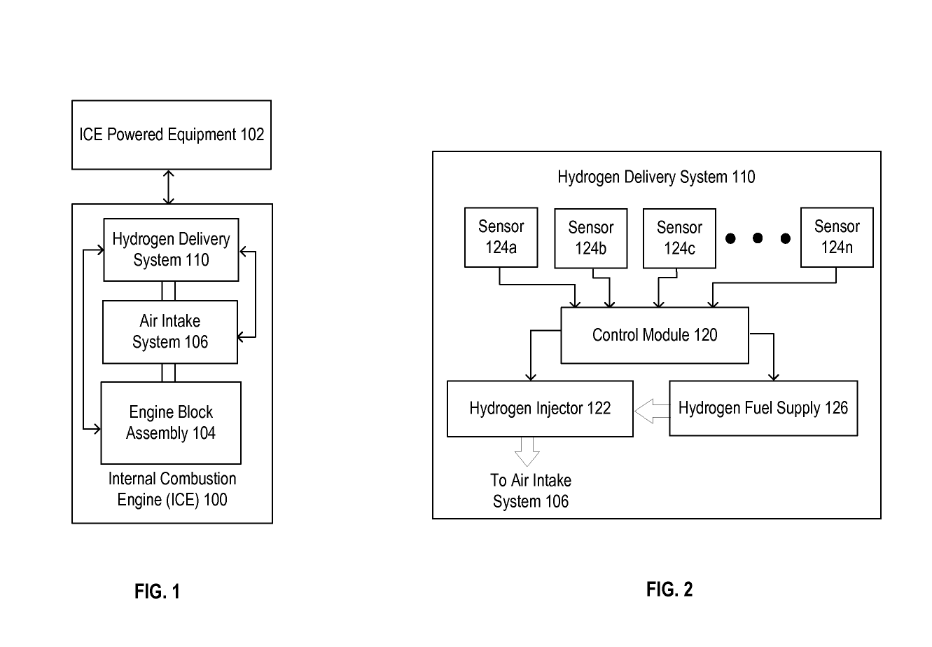

FIG. 1 is a schematic block diagram of an embodiment of an internal combustion engine with a hydrogen delivery system in accordance with the present invention. FIG. 1 illustrates an internal combustion engine (ICE) 100 coupled to an ICE powered equipment 102. The ICE powered equipment 102 includes for example, vehicles, airplanes, locomotives, generators, oil field equipment and other applications. The ICE 100 includes an engine block assembly 104, an air intake system 106 and a hydrogen delivery system 110 coupled to the air intake system 106. The engine block assembly 104 includes the engine block, cylinders and pistons or rotors. The air intake system 106 delivers air to the cylinders in the engine block assembly 104. The air intake system 106 may include a turbocharger and air filter.

In operation, the hydrogen delivery system 110 monitors the air flow rate through the air intake system 106 and controls the injection of hydrogen into the air intake system 106 to produce a desired, predetermined hydrogen to air ratio. In an embodiment, the hydrogen may be injected after the turbocharger in the air intake system 106. In another embodiment, the hydrogen may be injected before the turbocharger such that it pressurizes the air and hydrogen together. This helps to mix the hydrogen and air and more uniformly distribute the hydrogen in the air.

FIG. 2 is a schematic block diagram of an embodiment of the hydrogen delivery system 110 in accordance with the present invention. The hydrogen delivery system 110 includes a control module 120, a hydrogen injector 122, one or more sensors 124a-n and a hydrogen fuel supply 126. The control module 120 is a processing device including a microprocessor, micro-controller, digital signal processor, microcomputer, central processing unit, field programmable gate array, programmable logic device, state machine, logic circuitry, analog circuitry, digital circuitry, or any device that manipulates signals (analog and/or digital) based on hard coding of the circuitry or operational instructions. The processing device may have an associated memory element, which may be a single memory device, a plurality of memory devices, or embedded circuitry of the control module. Such a memory device may be a read-only memory, random access memory, volatile memory, non-volatile memory, static memory, dynamic memory, flash memory, cache memory, and/or any device that stores digital information. Note that when the control module implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. Further note that, the memory element stores, and the control module executes, hard coded and/or operational instructions corresponding to at least some of the steps and/or functions illustrated in FIGS. 1-6 herein.

The sensors 124a-n measure operational data of the internal combustion engine 100. The sensors may be coupled to the engine block assembly 104, the air intake system 106, hydrogen delivery system 110. The sensors 124a-n include, inter alia, thermometers, throttle body position sensors, revolutions per minute (RPM) sensor, pressure sensors, volume flow sensor, or mass air flow sensor, such as hot film or hot wire sensorbarametric pressure sensor, Cam Shaft Position Sensor, Crank Shaft Position Sensor, Exhaust Back Pressure sensor, engine oil temperature sensor, engine oil pressure sensor, exhaust back pressure regulator, Fuel Delivery Control Signal, Glow Plug Relay, Hydraulically Actuated Electronically controlled Unit Injector, Intake Air Temperature, Injection Control Pressure, Injection Pressure Regulator, Injector Driver Module, Injector Driver Module Enable, Injection Control Pressure Regulator, Idle Validation Switch, Manifold Absolute Pressure, Manifold Air Temperature Sensor, Power train Control Module sensor, Speed Control Command Switch sensor, tachometer output sensor, Accelerator Position Sensor, Hall Effect Sensor, Magnetic Pick Up (Magnetic Speed Sensor), Thermister, Alternator Charge Output Signal, Vehicle Speed Sensor, Vacuum Sensor, Alternator Output Signal sensor, Glow Plug Control sensor, Vehicle Power Supply sensor, vehicle Reference Voltage sensor, and Wastegate Control sensor.

The hydrogen injector 122 may be a high pressure injector or a low pressure injector depending on the pressure of the hydrogen fuel and the volume of hydrogen needed to be injected into the air intake system 106.

In operation, one or more of the sensors 124a-n provide measurements of operational data of the internal combustion engine 110. The measurements of operation data may include, inter alia, measurements of mass air flow, volume air flow, vacuum, temperature, engine RPM, manifold absolute pressure, throttle position, engine load, crank shaft position or other operational data. The control module 120 monitors the operational data from the sensors 124a-n and determines a desired amount, either volume or mass, of hydrogen fuel to be injected into the air intake system 106 in response to the measurements of operational data. As the operational data changes, for example due to increase or decrease in the engine RPM, air flow, or other changes, the control module 120 continually updates the desired amount of hydrogen fuel to be injected into the air intake system 106. The control module 120 then controls the hydrogen injector 122 to provide a flow rate of hydrogen fuel to the air intake system 106 to deliver the determined amount of hydrogen fuel.

For example, in an embodiment, the control module 120 receives operational data of the engine RPM from one or more of the sensors 124a-n. Based on the engine RPM data, the control module 120 determines the desired volume or mass of hydrogen fuel to be injected into the air intake system 106. The control module 120 then controls the hydrogen injector 122 to provide a flow rate of hydrogen fuel to the air intake system 106 to deliver the desired volume or mass of hydrogen. In another embodiment, the control module 120 receives operational data of the throttle position from one or more of the sensors 124a-n. Based on the throttle position data, the control module 120 determines the desired volume or mass of hydrogen fuel to be injected into the air intake system 106. In another embodiment, the control module 120 receives operational data of the air flow from the mass air flow sensor through the air intake system 106. Based on the mass air flow data, the control model determines the desired volume or mass of hydrogen fuel to be injected into the air intake system 106.

In another embodiment, a sensor 124a-n provides operational data relating to the speed of a turbocharger rotor in the internal combustion engine 100. Based on the turbocharger rotor speed data, the control module 120 determines the desired amount of hydrogen fuel to be injected into the air intake system 106. In another embodiment, a sensor 124a-n provides operational data relating to amount of fuel, such as diesel or gasoline or other type of fuel, injected into a combustion chamber of the engine block assembly 104. The control module 120 may then correlate the fuel operational data to RPM of the engine block assembly 104 and determine the desired amount of hydrogen fuel to be injected into the air intake system 106. In another embodiment, a sensor 124a-n provides operational data relating to intake vacuum on a turbocharger in an internal combustion engine 100. Based on the operational data of the intake vacuum, the control module 120 may determine the desired amount of hydrogen fuel to be injected into the air intake system 106. In an embodiment with an internal combustion engine 100 having a set operational RPM, such as a generator with a set RPM during operation, the control module 120 may determine the desired amount of hydrogen fuel to be injected into the air intake system 106 based on one of these measurements.

In another embodiment, the control module 120 receives one or more measurements of operational data comprising of, inter alia, mass air flow, volume air flow, intake vacuum on a turbocharger, turbocharger rotor speed, amount of fuel injected into the engine block assembly 104, temperature, engine RPM, manifold absolute pressure, throttle position, engine load and crank shaft position and determines an amount of hydrogen fuel to be injected into the air intake system 106 based on one or more of the measurements of operational data.

In an embodiment, the hydrogen fuel supply 126 is a tank or other type of container with high pressure hydrogen fuel. The hydrogen fuel may include hydrogen H₂, oxygen, methane, propane and any combination of these gases or other hydrogen/carbon based gases. In another embodiment, the hydrogen fuel source 126 is a hydrogen generator, such as an electrolyser. In this embodiment, the hydrogen fuel includes an electrolyser gas consisting of hydrogen 2H₂ and oxygen O₂. The control module 120 monitors the hydrogen fuel supply 126 to determine a pressure of the hydrogen fuel. Depending on the pressure of the hydrogen fuel, the type of hydrogen fuel, the control module 120 controls the opening and closing of the hydrogen injector 122. The hydrogen injector 122 injects the desired flow rate of hydrogen into the air intake system 106 in response to control signals from the control module 120.

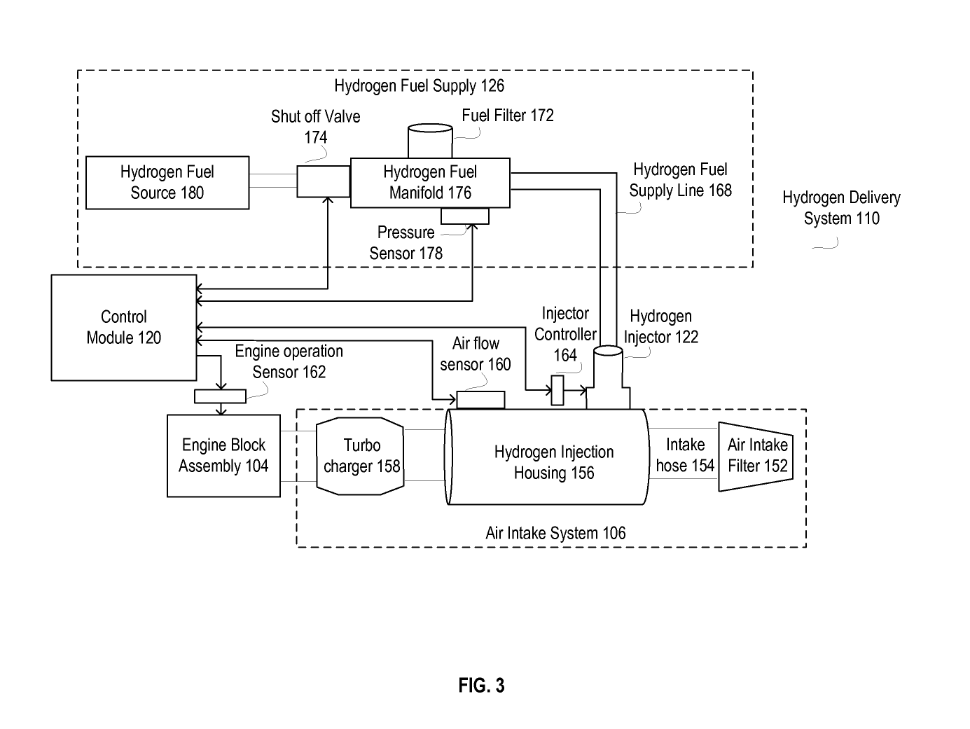

FIG. 3 illustrates a schematic block diagram of an embodiment of the hydrogen delivery system 110 in accordance with the present invention. The air intake system 106 includes an air intake filter 152, an intake hose 154, a hydrogen injection housing 156 and a turbocharger 158. An air flow sensor 160 is coupled to the hydrogen injection housing 156 to provide measurements of air flow in the hydrogen injection housing 156. In an embodiment, the air flow sensor 160 is a mass air flow sensor, such as a hot wire or hot film anemometer. In an embodiment, an engine operation sensor 162 is coupled to the engine block assembly or component of the internal combustion engine 100. The engine operation sensor 162 is operable to detect whether the engine is operational by detecting any RPM of the engine 100 or ignition or other means. The air flow sensor 160 and engine operation sensor 162 each may comprise one of the sensors 124a-n described in FIG. 2. Other sensors 124a-n may also provide one or more additional measurements to the control module 120 as described with respect to FIG. 2.

Referring again to FIG. 3, the hydrogen fuel injector 122 is coupled to the hydrogen injection housing 156 in the air intake system 160. The hydrogen injection housing 156 may be mounted to an existing internal combustion engine 104 or be incorporated into manufacture of a new internal combustion engine 104. The hydrogen fuel injector 122 and air flow sensor 160 are mounted before the turbocharger 158. In another embodiment, the hydrogen fuel injector 122 and air flow sensor 160 may be mounted after the turbocharger 158. An injector controller 164 is coupled to the hydrogen fuel injector 122 and the control module 120. Depending on the implementation of the hydrogen fuel supply 126, the injector controller 164 may be incorporated as a component of the hydrogen injector 122 or as a separate component. The injector controller 164 is operable to control the opening and closing of the hydrogen injector 122 in response to control signals from the control module 120.

The hydrogen fuel supply 126 is coupled to the hydrogen injector 122. The hydrogen fuel supply 126 includes a hydrogen fuel supply line 168, a fuel filter 172, a shut off valve 174, a hydrogen fuel manifold 176, a pressure sensor 178 and a hydrogen fuel source 180. The pressure sensor 178 is coupled to the hydrogen fuel manifold 176 or shut off valve or other component of the hydrogen fuel supply 126 to measure the pressure of the hydrogen fuel. The pressure sensor 178 may comprise one of the sensors 124a-n described in FIG. 2. The shut off valve 174 is a solenoid valve or other safety valve. The fuel filter 172 is operable to filter contaminates and moisture from the hydrogen fuel.

In operation, the control module 120 receives pressure measurements from the pressure sensor 178 and determines whether the pressure is within operating conditions. When the pressure exceeds or falls below operating conditions, the control module 120 signals the shut off valve 174 to close to protect the system integrity. In addition, the control module 120 receives data from the engine operation sensor 162 and determines whether the internal combustion engine 100 is operational or running. In response to the determination that the engine 100 is operational, the control module 120 signals the shut off valve 174 to open or in response to a determination that the engine 100 is not operational, the control module 120 signals the shut off valve 174 to close. When the pressure is within operating conditions and the engine is operational, the control module 120 determines an air flow rate and then determines a flow rate of the hydrogen fuel into the air intake system 106 to produce a predetermined hydrogen to air ratio in the air intake system 106.

In an embodiment, the control module 120 may determine a volume air flow rate or a mass air flow rate. The control module 120 receives air flow measurements from the air flow sensor 160. The volume air flow rate is determined in response to the air flow measurements and air flow area of the hydrogen injection housing 156. The control module 120 may also receive air pressure measurements and air temperature measurements. From these measurements, the control module 120 may determine the approximate density of the air to determine mass air flow rate from the volume air flow rate. In another embodiment, the control module 120 may determine the mass air flow rate from the air flow sensor 160 when the air flow sensor is a mass air flow sensor such as a hot film or hot wire anemometer.

The control module 120 then determines the flow rate of the hydrogen fuel in response to the air flow rate. The control module 120 determines the hydrogen flow rate needed to provide a predetermined hydrogen to air ratio in the air intake system 106 or engine block assembly 104. The hydrogen flow rate determined also depends on the percentage of hydrogen in the hydrogen fuel. For example, when the hydrogen fuel source 180 is a tank with pressurized hydrogen, the hydrogen fuel will have a high percentage of hydrogen. However, when the hydrogen fuel source is an electrolyser, the percentage of hydrogen in the hydrogen fuel is a lower percentage. The control module 120 is programmed for the specified type of hydrogen based fuel. To produce predetermined hydrogen to air ratio in the air intake system 106, the control module 120 determines the flow rate of the hydrogen fuel into the hydrogen injection housing 156 in response to air flow, engine load or RPM. The control module 120 then controls injection of the hydrogen fuel into the air intake system to produce the predetermined hydrogen to air ratio. Variable hydrogen fuel concentrations are compensated by the control module 120 programming to ensure the predetermined hydrogen to air ratio is maintained. As the engine load and RPM increases or decreases and the air flow rate increases or decreases, the control module 120 continues to monitor the air flow rate and adjust the hydrogen flow rate into the air intake system to produce a predetermined hydrogen to air ratio.

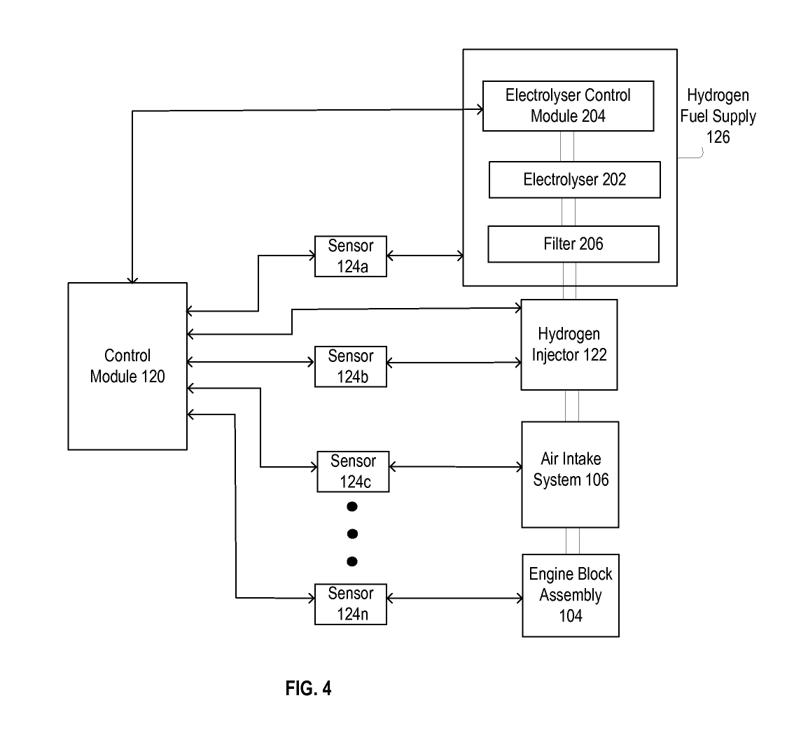

FIG. 4 is a schematic block diagram of another embodiment of the hydrogen delivery system 110 in accordance with the present invention. In this embodiment, the hydrogen fuel supply 126 includes an electrolyser 202, electrolyser control module 204 and filter 206. The electrolyzer 202 generates hydrogen and oxygen by a process of electrolysis that separates hydrogen from water. The electrolyzer 202 includes one or more electrodes in a water and electrolyte mixture. An electric current flows through the water and electrolyte mixture and oxygen (O₂) and hydrogen gas (H₂) are generated. The electrolyzer control module 204 controls the electrolyser 202 and is operable to regulate the fuel production of the electrolyzer 202. By regulating the current flow, the volume of oxygen (O₂) and hydrogen gas (H₂) generated by the electrolyzer may be adjusted. The generated oxygen (O₂) and hydrogen gas (H₂) comprise the hydrogen fuel. The optional use of an oxygen separation filter 206 in the electrolyzer fuel supply 126 reduces the oxygen in the hydrogen fuel generated by the electrolyzer 202. In this embodiment, the hydrogen fuel supply 126 may also include check valves, expansion chambers, flashback prevention components, pressure switches or other components. The electrolyzer 202 may be powered by an alternator, battery or other means. The electrolyzer control module 204 is a processing device including a microprocessor, micro-controller, digital signal processor, microcomputer, central processing unit, field programmable gate array, programmable logic device, state machine, logic circuitry, analog circuitry, digital circuitry, or any device that manipulates signals (analog and/or digital) based on hard coding of the circuitry or operational instructions. The processing device may have an associated memory element, which may be a single memory device, a plurality of memory devices, or embedded circuitry of the control module. Such a memory device may be a read-only memory, random access memory, volatile memory, non-volatile memory, static memory, dynamic memory, flash memory, cache memory, and/or any device that stores digital information. Note that when the control module implements one or more of its functions via a state machine, analog circuitry, digital circuitry, and/or logic circuitry, the memory element storing the corresponding operational instructions may be embedded within, or external to, the circuitry comprising the state machine, analog circuitry, digital circuitry, and/or logic circuitry. Further note that, the memory element stores, and the control module executes, hard coded and/or operational instructions corresponding to at least some of the steps and/or functions illustrated in FIGS. 1-6 herein.

In operation, the control module 120 monitors, inter alia, the flow rate, pressure or volume of the hydrogen fuel from the hydrogen fuel supply 126. To adjust the hydrogen fuel generated, the control module 120 transmits an electrolyser control signal to the electrolyser control module 204. In response to the electrolyser control signal, the electrolyser control module 204 starts or terminates production of hydrogen fuel by the electrolyser 202. The control module 120 receives data from the engine operation sensor 162 and determines whether the internal combustion engine 100 is operational or running. In response to the determination that the engine 100 is operational, the control module 120 signals the electrolyser control module 204 to start production. In response to a determination that the engine 100 is not operational, the control module 120 signals the electrolyser control module 204 to terminate production.

In another embodiment, the electrolyser control module 204 regulates the voltage or current applied to the electrolyser 202. The control module 120 can thus control the rate of production of hydrogen fuel in response to the flow rate needed at the hydrogen injector 122.

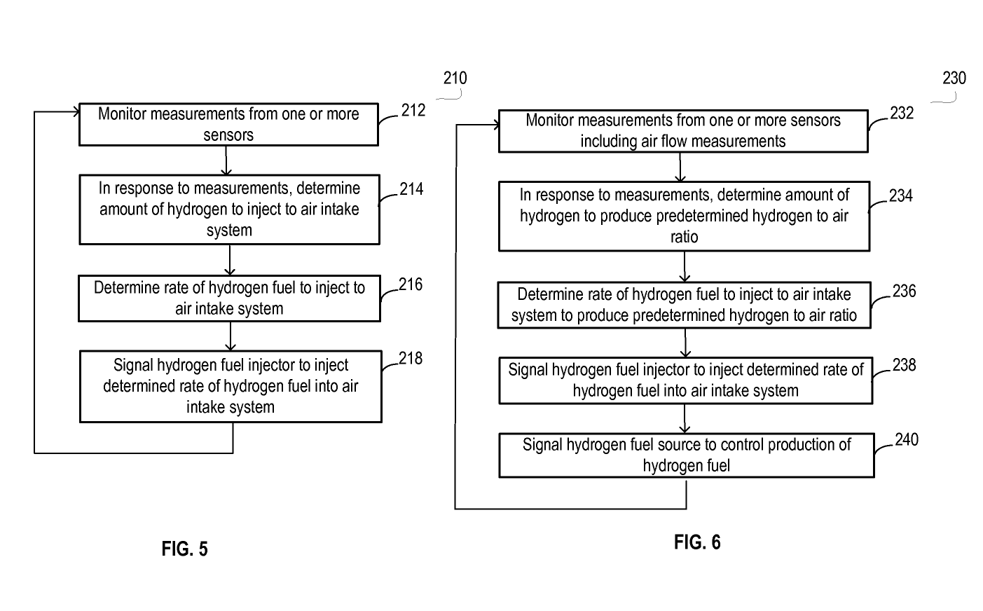

FIG. 5 is a logic flow diagram of a method 210 for hydrogen delivery to an air intake system 106 of an internal combustion engine 100 in accordance with the present invention. In step 212, one or more measurements from one or more sensors are monitored on a continuous basis as the operating conditions of the internal combustion engine change. For example, the measurements of operation data may include, inter alia, measurements of mass air flow, volume air flow, vacuum, temperature, engine RPM, manifold absolute pressure, throttle position, engine load and crank shaft position.

In step 214, an amount of hydrogen, either volume or mass of hydrogen, to inject into the air intake system 106 of the internal combustion engine 100 is determined. The control module 120 monitors the operational data from the sensors 124 and determines a desired volume or mass of hydrogen to be injected into the air intake system 106 in response to the measurements of operational data. For example, in an embodiment, the control module 120 receives operational data of the engine RPM. Based on the engine RPM, the control module determines the desired volume or mass of hydrogen to be injected into the air intake system 106. The control module 120 then controls the hydrogen injector 122 to provide a flow rate of hydrogen fuel to the air intake system 106 to deliver the desired volume or mass of hydrogen. In another embodiment, the control module 120 receives operational data of the throttle position. Based on the throttle position, the control module determines the desired volume or mass of hydrogen to be injected into the air intake system 106.

In step 216, a flow rate for hydrogen fuel is determined in response to the amount of hydrogen needed to inject into the air intake system. In step 218, the injection of hydrogen fuel into the air intake system is controlled to approximately meet the determined flow rate for hydrogen fuel.

FIG. 6 is a logic flow diagram of another embodiment of a method 230 for hydrogen delivery in accordance with the present invention. In step 232, measurements of the air flow through the air intake system are monitored along with other measurements from sensors 124a-n needed to determine the volume air flow or mass air flow through the air intake system 106. For example, the control module 120 may also receive air pressure measurements and air temperature measurements. From these measurements, the control module 120 may determine the approximate density of the air to determine mass air flow rate from the volume air flow rate. In another embodiment, the control module 120 may determine the mass air flow rate from the air flow sensor 160 when the air flow sensor is a mass air flow sensor such as a hot film or hot wire anemometer.

In step 234, the amount of hydrogen to produce a predetermined hydrogen to air ratio is determined in response to the air flow rate. In step 236, the flow rate of the hydrogen fuel needed to provide the amount of hydrogen for the predetermined hydrogen to air ratio in the air intake system 106 is determined. The hydrogen flow rate depends on the percentage of hydrogen in the hydrogen fuel and pressure of hydrogen fuel. In step 238, a signal controls the injection of the hydrogen fuel into the air intake system to produce the predetermined hydrogen to air ratio. In step 240, in an embodiment with an electrolyser, the generation of hydrogen fuel by the hydrogen fuel source is controlled in response to the determined flow rate for the hydrogen fuel. The process then continues back to step 232. As the operational conditions of the internal combustion engine changes 100, the control module 120 continues to monitor the air flow rate and adjust the hydrogen flow rate into the air intake system to produce a predetermined hydrogen to air ratio. The predetermined hydrogen to air ratio may be adjusted depending on the type of engine. For example, the hydrogen to air ratio may range from 0.01% to 5.0% for certain diesel engines and more or less than this ratio for other types of engines. Typically, however, the ratio will be less than 3% of hydrogen to air.

Embodiments of the present invention are thus able to adjust the delivery of the volume or flow rate of the hydrogen fuel to maintain a approximately predetermined hydrogen to air ratio with varying engine RPM and load conditions of the internal combustion engine. This adjustment helps to increase efficiency of the combustion process over the engine's operating range. With hydrogen gas blending, the emissions of any ICE are greatly reduced across the engines entire operating range.

The hydrogen delivery system 110 can be installed on existing internal combustion engines as well as constructed as part of a new internal combustion engine. It should further be understood that the above described embodiments are not limited to any particular shape, dimensions or size or materials. The hydrogen delivery system 110 may be adjusted in scale and in shape to be operable with various types and capacities of internal combustion engines. For example, the hydrogen delivery system 110 may be scaled to be operable with 1.0 L gasoline engine for a vehicle or 50 L diesel engine for a generator. The embodiments of the invention described are not limited to the exact details of construction, operation, exact materials or embodiments shown and described, but includes modifications and equivalents that are apparent to one skilled in the art. As may be used herein, the term “approximately” provides an industry-accepted tolerance for its corresponding term. Such an industry-accepted tolerance ranges from less than one percent to fifty percent and corresponds to, but is not limited to, ratio values, process variations, temperature variations, etc.

In the above description, the hydrogen fuel may include hydrogen H₂, oxygen, methane, propane and any combination of these gases or other hydrogen/carbon based gases. When other carbon based gases are incorporated into the fuel, or used in place of hydrogen, the embodiments in FIGS. 1 through 6 may also be used to deliver such fuel to an engine block assembly 104. As described herein, the control module 120 determines an amount of the fuel to produce a predetermined gas to air ratio in response to one or more measurements of operational data. The flow rate of the fuel needed to provide the amount of gas is determined and an injector is controlled to provide the injection of the fuel into the air intake system to or engine block assembly 104.

As may also be used herein, the terms “coupled to” or “coupling” includes direct coupling between items and/or indirect coupling between items via an intervening item (e.g., an item includes, but is not limited to, a component, an element, a circuit, and/or a module) so that the items are operable for their intended purpose. As may further be used herein, inferred coupling (i.e., where one element is coupled to another element by inference) includes direct and indirect coupling between two items in the same manner as “coupled to”. As may even further be used herein, the term “operable to” or “operatively” indicates that an item includes elements necessary to perform one or more of its corresponding functions and may further include inferred coupling to one or more other items. As may still further be used herein, the term “associated with”, includes direct and/or indirect coupling of separate items and/or one item being embedded within another item.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of schematic block diagrams that are functional building blocks illustrating the performance of certain significant functions. The boundaries of these functional building blocks have been arbitrarily defined for convenience of description. Alternate boundaries could be defined as long as the certain significant functions are appropriately performed. One of average skill in the art will also recognize that the functional building blocks can be implemented as illustrated or by including other functional building blocks into a single functional building block or separating a functional building block into more than one component or including additional or alternative building blocks that perform similar functions.

What is claimed is:

1. An internal combustion engine, comprising:
an engine block assembly,
an air intake system coupled to the engine block assembly; and
a hydrogen delivery system coupled to the air intake system, wherein the hydrogen delivery system monitors an air flow rate through the air intake system and controls injection of hydrogen fuel into the air intake system to produce a predetermined hydrogen to air ratio.

2. The internal combustion engine of claim 1, wherein the hydrogen delivery system further comprises:
an air flow sensor coupled to the air intake system for providing measurements relating to air flow through the air intake system.

3. The internal combustion engine of claim 2, wherein the hydrogen delivery system further comprises:
a control module that is operable to determine air flow rate through the air intake system in response to the measurements relating to air flow and to determine an amount of hydrogen fuel to inject into the air intake system.

4. The internal combustion engine of claim 3, wherein the hydrogen delivery system further comprises:
a hydrogen injector operable to inject the determined amount of hydrogen into the air intake system in response to control signals from the control module.

5. The internal combustion engine of claim 4, wherein the hydrogen delivery system further comprises:
a hydrogen fuel supply that provides hydrogen fuel to the hydrogen injector.

6. The internal combustion engine of claim 5, wherein the hydrogen fuel supply comprises:
an electrolyzer; and
an electrolyzer control module that receives signals from the control module to produce hydrogen fuel.

7. The internal combustion engine of claim 6, wherein the air intake system comprises:
a hydrogen injection housing coupled to the air flow sensor and the hydrogen injector.

8. The internal combustion engine of claim 7, wherein the air intake system comprises:
a hydrogen injection housing coupled before or after the turbocharger when applicable.

9. A method for hydrogen delivery to an internal combustion engine, comprising:
monitoring measurements from one or more sensors coupled to the internal combustion engine; and
adjusting a rate of hydrogen fuel injected into an air intake system in response to the measurements from the one or more sensors, wherein adjusting the rate of hydrogen fuel comprises:
in response to the measurements, determining an amount of hydrogen to deliver to an air intake system of the internal combustion engine;
determining a rate of hydrogen fuel to inject to the air intake system to deliver the determined amount of hydrogen to the air intake system; and
signaling a hydrogen fuel injector to inject the rate of hydrogen fuel into the air intake system.

10. The method for hydrogen delivery to an internal combustion engine of claim 9, further comprising:
signaling a hydrogen fuel source to regulate production of hydrogen fuel in response to the rate of hydrogen fuel injected into the air intake system.

11. The method for hydrogen delivery to an internal combustion engine of claim 9, further comprising:
signaling a hydrogen fuel source to start or terminate production of hydrogen fuel in response to engine operation.

12. The method for hydrogen delivery to an internal combustion engine of claim 9, wherein monitoring measurements from one or more sensors coupled to the internal combustion engine comprises monitoring measurements of at least one of the following: mass air flow, volume air flow, engine revolutions per minute (RPM), manifold absolute pressure, throttle position, engine load and crank shaft position.

13. The method for hydrogen delivery to an internal combustion engine of claim 12, wherein monitoring measurements from one or more sensors coupled to the internal combustion engine comprises monitoring measurements of air flow through the air intake system.

14. The method for hydrogen delivery to an internal combustion engine of claim 13, wherein adjusting the rate of hydrogen fuel further comprises:
determining an air flow rate in response to the measurements of air flow through the air intake system.

15. The method for hydrogen delivery to an internal combustion engine of claim 14, wherein the step of determining an amount of hydrogen to deliver to an air intake system of the internal combustion engine comprises:
in response to the air flow rate, determining an amount of hydrogen to deliver to the air intake to produce a predetermined hydrogen to air ratio.
